(19) United States
(12) Patent Application Publication
(10) Pub. No.: US 2009/0014266 A1
(43) Pub. Date: Jan. 15, 2009

(54) Adjustable fluid friction valve

(76) Inventor: Donald Clifton Maser, Altoona, PA (US)

Correspondence Address: DONALD CLIFTON MASER, 325 BELL AVE, ALTOONA, PA, 16602-4937, US

(21) Appl. No.: 11/827,021

(22) Filed: Jul. 10, 2007

(51) Int. Cl. F16F 9/34

(52) U.S. Cl. 188/318; 188/313; 188/322.13

(57) ABSTRACT

The present invention is an adjustable fluid friction valve. It is comprised of a left cap, a casing, a right cap, a fluid reservoir, a rotated-member, a stem, and an adjustment grip. The adjustment grip is turned by the user's hand and connects to and turns the central stem that connects to and turns the rotated-member. The rotated-member communicates fluid flow to different cross-sections of an annular passage that is disposed in the left cap where it is used for variable flow restriction. It is a groove having a varying cross-sectional area along its length with a smaller beginning terminal and a larger concluding terminal. The smaller beginning terminal is blind and the larger concluding terminal communicates with the mid passage of the left cap. The mid passage communicates with the fluid reservoir. The annular passage receives fluid flow from the rotated-member at a cross-section of its length. A smaller cross-section is accompanied by a longer length. Both these conditions increase fluid friction in the valve and have a restricting effect on its fluid flow. A restricted fluid flow increases the force required to push fluid through the valve and any connected external hydraulic circuit, thereby increasing the dampening effect inside the circuit. A grip stopping means is easily added to the grip to stop its rotation in incremental steps.

### CROSS REFERENCE TO RELATED APPLICATIONS

Not applicable

### BACKGROUND

1. Technical Field

The present invention relates to a valve that is a hydraulic device for use in conjunction with another hydraulic device having a cylinder and a piston such as a hydraulic cylinder or a hydraulic damper.

2. Description of the Related Art

Presently the more advanced hydraulic dampers are adjustable and have a flow control valve disposed within them. This valve uses fluid friction to restrict fluid flow through an internal circuit within the damper. The damper is self-contained in a single housed unit and has an integral grip for the adjustment of its valve. The valve changes the amount of force required to operate the damper. In some instances, the hydraulic damper along with its integral grip must be buried within another machine. The grip becomes inaccessible. The present invention solves this problem by separating the grip from the damper.

The device described in U.S. Pat. No. 4,591,032 (1986) to Itazu is an example of the present self-contained adjustable hydraulic damper. The internal valve in Itazu's patent is similar in operation to the external valve in the present invention (see FIGS. 5, 6, and 7 reference numeral 57 of Itazu's patent,) but the present invention does not require a hollow stem and a hollow rotated-member as Itazu's device does (see FIG. 5 reference numerals 36 and 44 respectively of Itazu's patent.)

The following are other advantages of the present invention: It can be produced economically in small lots because it is made by basic inexpensive machining and manufacturing operations. It can be connected to two dampers at the same time by adding an external check valve to each damper. It has an inexpensive and effective outer seal because the seal is disposed at its low-pressure end. Its annular passage groove is easily milled with a standard woodruff key seat cutter. It has better heat dissipation than one self-contained device because the working fluid of its circuit is exposed to a greater surface area. Its surface area is spread over two devices and two external conduits.

### SUMMARY

The object of the present invention is to move the adjustment grip of a hydraulic damper to a separate remote location so that it is easily accessible while leaving the hydraulic damper itself buried within a larger machine. To further understand this new arrangement one must visualize the adjustment grip and its associated parts being stripped and discarded from the present hydraulic damper and a similar adjustment grip and its parts being placed in a separate device remote from the stripped hydraulic damper. This separate device is an adjustable fluid friction valve. The valve has a left and a right port that connects it with a hydraulic circuit that includes the stripped hydraulic damper.

Accordingly the present invention is an adjustable fluid friction valve for use in a hydraulic circuit and has these items located on the same longitudinal axis: a left cap, a casing, a right cap, a fluid reservoir, a stem, a stem retaining ring, and a grip. The left cap has a single annular passage on one of its internal diameters for the variable restriction of fluid flow. This annular passage is a groove that has a varying cross-sectional area along its length with a smaller beginning terminal and a larger concluding terminal. The smaller beginning terminal is blind and the larger concluding terminal communicates with a mid passage that communicates with the fluid reservoir. The fluid reservoir communicates with a right port that connects to the hydraulic circuit. The opposite end of the hydraulic circuit connects back to the friction valve at its left port that communicates with a bent passage disposed within a rotated-member. The bent passage directs fluid flow to different portions of the annular passage. The rotated-member is rotated around the longitudinal axis and is moved in this rotation by the rotation of the stem. The stem is rotated by the grip and the grip is connected to the stem with a fastening means.

The grip of the friction valve is adjusted by the user to adjust the force required to produce a desired flow of fluid through the friction valve and the hydraulic circuit.

### DRAWING FIGURES

In the description the directions left and right are used to name items. In viewing FIGS. 1, 2, and 3, the viewer's left or right is applied to the appropriately named item. The tilt of the perspective drawings puts the direction (left) towards the lower left corner of the drawing, and the direction (right) towards the upper right corner of the drawing. Only the main item of a standard and well known fastening arrangement is given a reference numeral.

FIG. 1 is a perspective view showing the complete device connected to fluid conduits.

FIG. 2 is an exploded perspective view showing the complete device taken apart.

FIG. 3 is a section taken along line 3-3 of FIG. 1.

FIG. 4 is an enlarged view taken along line 4-4 of FIG. 2.

FIG. 5 is an enlarged view taken along line 5-5 of FIG. 2.

FIG. 6 is an enlarged view taken along line 6-6 of FIG. 2.

FIG. 7 is an enlarged view taken along line 7-7 of FIG. 2.

FIG. 8 is an enlarged view taken along line 8-8 of FIG. 2.

FIG. 9 is an enlarged view taken along line 9-9 of FIG. 2.

FIG. 10 is a view taken along line 10-10 of FIG. 9.

FIG. 11 is a schematic diagram illustrative of the manner in which the valve is connected to a hydraulic device.

FIG. 12 is schematic diagram illustrative of the manner in which the depth of the restriction of FIG. 4 varies annularly.

### REFERENCE NUMERALS

22 friction valve
24 right conduit
26 hydraulic damper
28 left conduit
30 left cap
32 cap recess
34 small portion
35 inner seal
36 cap recess
38 left flange
40 rotated-member
42 large portion
44 pin slot
46 left socket
50 left port
52 passage
54 bent passage
56 annular passage
58 mid passage
60 pin
64 stem
66 reservoir
68 casing
70 right flange
72 right cap
74 cap recess
76 cap recess
78 mark
80 ball
82 symbols
84 spring
88 grip
92 right socket
100 setscrew
104 outer seal
108 opening
110 right port
112 retaining ring
116a grip wing
116b grip wing
118 curve transition

Although one skilled in the art would have little trouble making the apparatus from the drawings, the reference-numeral list, and a statement of its use alone, the following text will further describe the apparatus for those without these special skills.

### DESCRIPTION

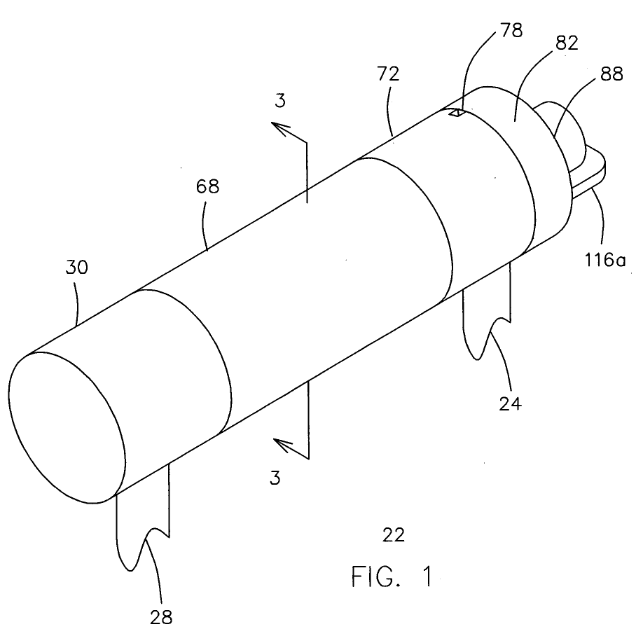

An embodiment of the present invention, friction valve 22, will be described herein in conjunction with drawing FIGS. 1-12. The drawings and the following description include a grip stopping means that is easily added to the device.

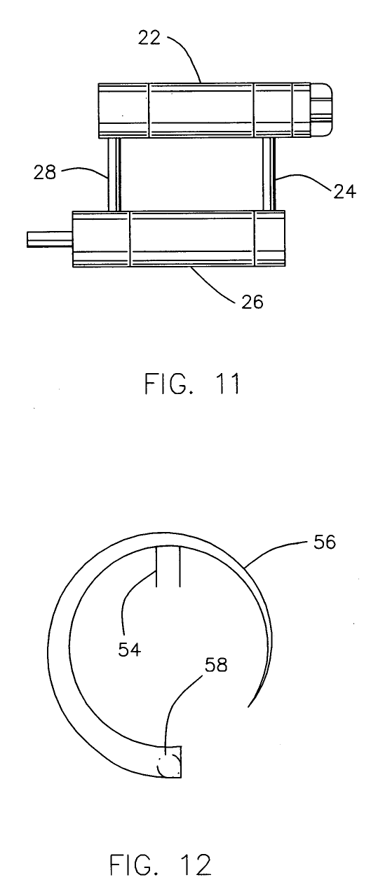

In FIG. 11, the friction valve 22 is in a circuit with a hydraulic damper 26. A left conduit 28 transports fluid from the damper 26 to the valve 22 and a right conduit 24 transports fluid from the valve 22 back to the damper 26 closing the circuit. Damper 26 is similar to a standard damper that is stripped down and therefore is nothing more than a positive displacement hydraulic-piston-pump with a check valve in the piston to keep the fluid flowing in one direction and to make the damper 26 a single acting damper. Either an internal or external spring is included with most dampers to passively return the piston to the end of its passive stroke so the damper is ready for the next active stroke.

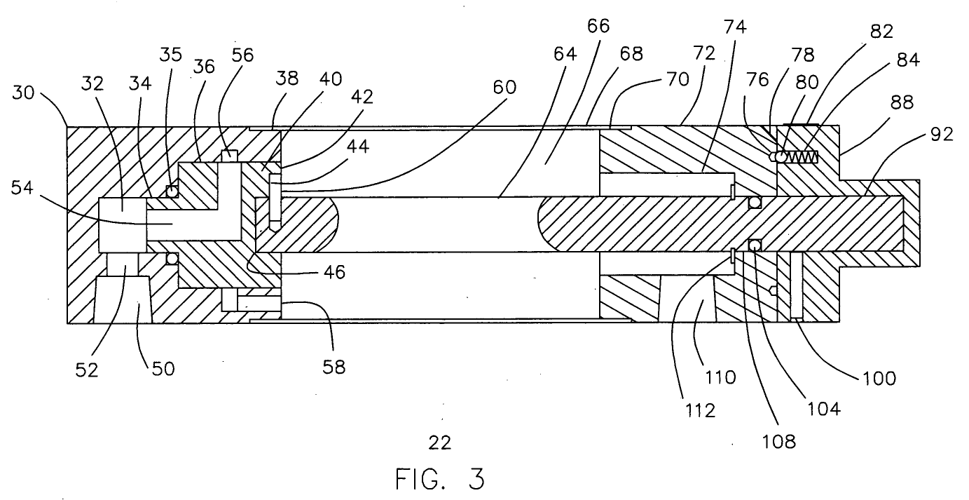

In FIG. 3, a single continuous internal fluid passage for the working oil of the friction valve 22 has these segments that in the following order communicate with each other and form a left to right flow path: left port 50, passage 52, cap recess 32, bent passage 54, annular passage 56, mid passage 58, fluid reservoir 66, cap recess 74, and right port 110.

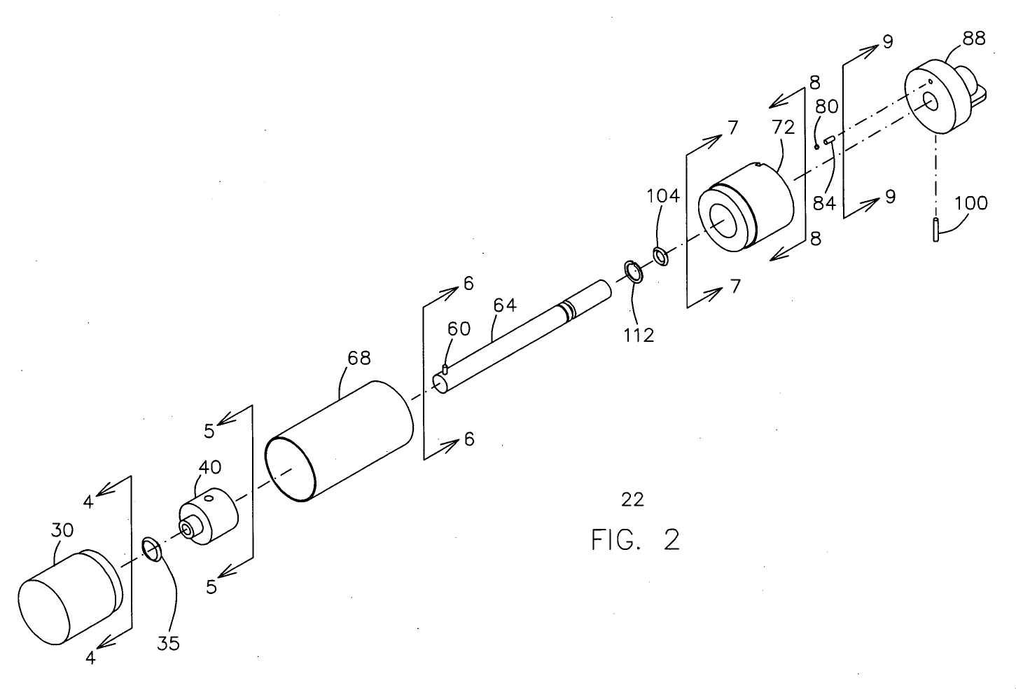

The friction valve 22 has a longitudinal axis that passes through the central axis of its major parts making them coaxial to the longitudinal axis of the valve. These parts are a left cap 30, a casing 68, a right cap 72, a fluid reservoir 66, a stem 64, a stem retaining ring 112, a grip 88, and a rotated-member 40. Each of these parts is made up of mostly cylindrical shapes. (See FIG. 2.)

The valve's parts are made out of metal with the exception of the grip 88 that is made out of a durable firm plastic and the o-ring seals 35 and 104 that are made out of rubber.

In FIG. 3, the left cap 30 of the friction valve 22 is a single machined piece that is cylindrical in shape with a central axis and has three internal recesses disposed on this central axis. These recesses communicate with each other and are concentric internal bores made in the right face of the left cap 30. The left most and smallest bore is cap recess 32 that houses the small portion 34 of the rotated-member 40 and forms part of the internal passage. The middle bore houses an inner seal 35 that is a standard o-ring seal. The last bore of the three is cap recess 36 that houses the large portion 42 of the rotated-member 40 and communicates with the fluid reservoir 66. Disposed on the internal diameter of this bore is a single annular passage 56 for the variable restriction of fluid flow that is a groove having a varying cross-sectional area along its length with a smaller beginning terminal and a larger concluding terminal, the smaller beginning terminal is blind, and the larger concluding terminal communicates with a mid passage 58 that is an axial hole that is drilled into the right face of the left cap 30. The mid passage 58 communicates with the fluid reservoir 66.

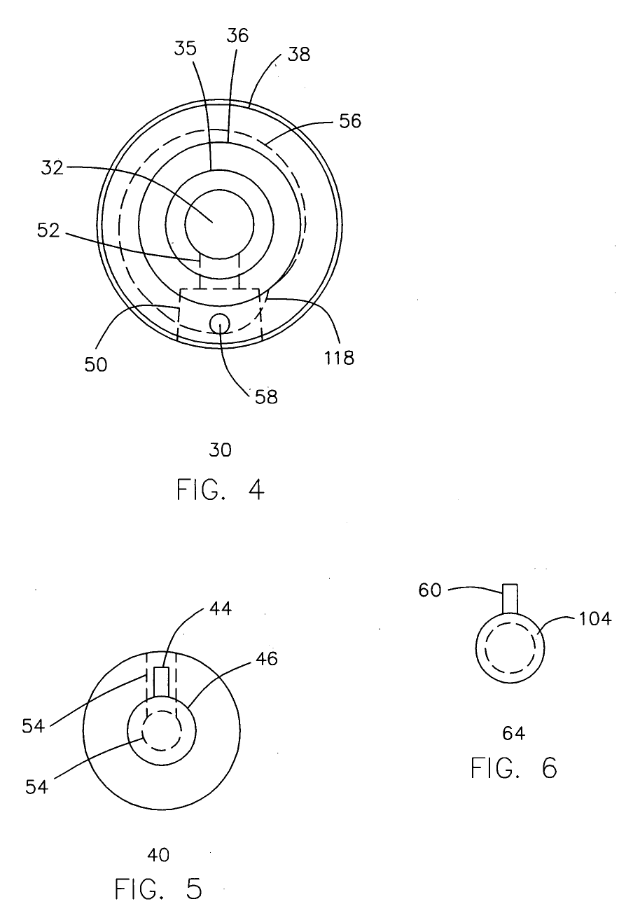

The annular passage 56 is made by mill cutting with a standard woodruff key seat-cutting tool in conjunction with a boring mill modified for annular milling. The radius of the cutting tool 118 is shown in FIG. 4 at the concluding terminal of the annular passage 56.

A diagram showing only the usable part of the annular passage 56, its cross-sectional variation, and the passages it communicates with is shown in FIG. 12.

In FIG. 3, the left cap 30 also has the following: (1) an external flange 38 disposed in its outside diameter on its right end to accommodate the left end of casing 68 and to give the external surface of the valve 22 a smooth flush appearance, (2) a small external ring groove (not shown) disposed in the left flange 38 for the left end of the casing 68 to be rolled into for a fluid tight connection between the left cap 30 and the casing 68, and (3) a left port 50 that is a pipe tapped hole that is disposed in the left cap 30 normal to the longitudinal axis of the friction valve 22 for a fluid tight connection between the left cap 30 and the left conduit 28.

Casing 68 is a thin walled tube cut to a predetermined length in order to produce an adequate fluid supply in the fluid reservoir 66.

The right cap 72 of the friction valve 22 is a single machined piece that is cylindrical in shape with a central axis that has a cap recess 74 and an opening 108 disposed on this central axis. The recess and the opening communicate with each other and are concentric internal bores. The larger bore that is cap recess 74 is made in the left face of the right cap 72. It forms part of the internal passage and communicates with the fluid reservoir 66. The right most and smallest bore that is opening 108 is a through bore made in the right face of right cap 72 to accommodate the stem 64. The right cap 72 also has the following: (1) an external flange 70 disposed in its outside diameter on its left end to accommodate the right end of casing 68 and to give the external surface of the valve 22 a smooth flush appearance, (2) a small external ring groove (not shown) disposed in the right flange 70 for the right end of the casing 68 to be rolled into for a fluid tight connection between the right cap 72 and the casing 68, (3) a distinctive mark 78, that is a recess, that is milled with an end mill in an axial direction at a 45 degree angle to the longitudinal axis of the friction valve 22 in the right outermost rim of the right cap 72, (4) an appropriate number of the occurrences of the cap recess 76 that is a blind drilled axial hole that is radially disposed in a ring centered around the longitudinal axis of the friction valve 22 (Each hole is drilled into the right face of the right cap 72), and (5) a right port 110 that is a pipe tapped hole that is disposed in the right cap 72 normal to the longitudinal axis of the friction valve 22 for a fluid tight connection between the right cap 72 and the right conduit 24.

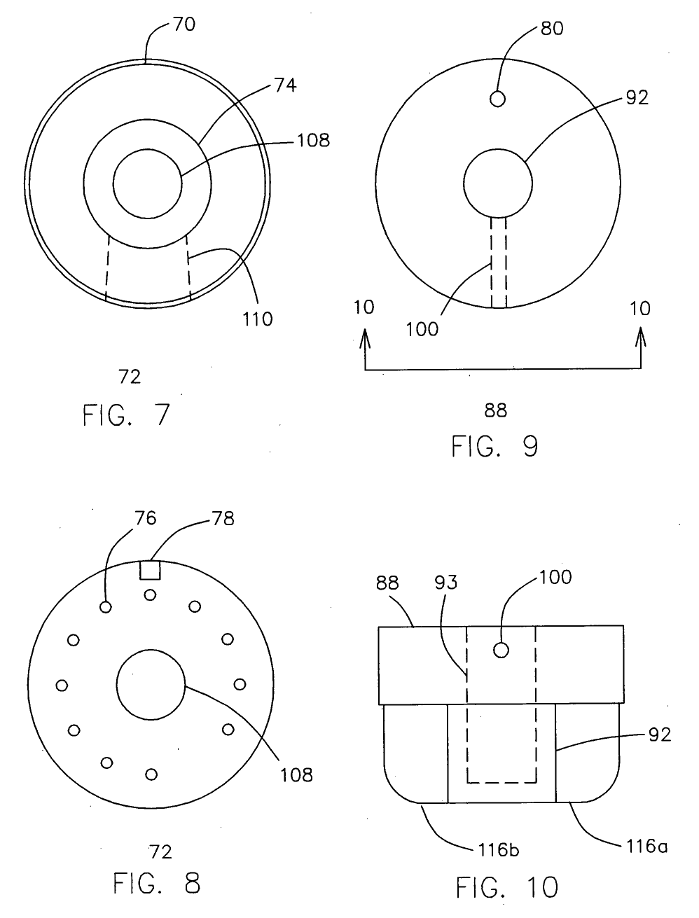

For the radial arrangement of the features of the right cap 72 just described see FIGS. 7 and 8.

In one alternative arrangement, a single friction valve is used with two dampers that have alternating active strokes. Each damper has an isolating check valve on its high-pressure discharge conduit. An additional left port 50 and right port 110 is needed in the friction valve 22 to accommodate the additional damper. In this arrangement the right ports may be modified to go directly into the fluid reservoir 66.

In FIG. 3, the grip 88 of friction valve 22 is a continuous molding and has a large left cylinder and a small right cylinder that are end joined cylinders on the same central axis of the grip 88. This central axis also has disposed upon it a coaxial socket 92 that is a recess that is made in the left face of the large cylinder that extends into the small cylinder. This coaxial recess accommodates the right end of stem 64. The grip 88 additionally has a grip stopping means that stops it incrementally in its rotation around the longitudinal axis of the friction valve 22 with a ball 80 that partially moves into one of the radially disposed recesses 76 of the right cap. The ball is urged by a spring 84. The spring along with the ball 80 is disposed in a recess that is a blind drilled axial hole in the grip 88. At different times each of the radially disposed cap recesses 76 line up with the single combined ball and spring recess while the grip 88 is being rotated stopping the grip 88 in increments of rotation. The ball 80 is held in the ball and spring recess by deformities (not shown) made in the open end of the recess by an impact driven deforming tool. The grip 88 also has the following: (1) a fastening means that connects the grip 88 to the stem 64 that is a standard setscrew 100 disposed normal to the longitudinal axis of the friction valve 22 in a threaded opening in one side of the large cylinder of the grip 88, (2) two grip wings 116a and 116b, for increasing the torque transmitted between the user hand and the grip 88, that are disposed on the right end of the grip 88 in opposing position to each other, that are a part of the continuous body of the grip 88, and that are molded into the large and small cylinders of the grip 88, and (3) a grip position indicator that is a series of sequential symbols 82 that are printed on a flexible adhesive tape that is applied to the outside diameter of the large cylinder of the grip 88 near its left end in opposed position to the distinctive mark 78 of the right cap 72.

For the radial arrangement of the features of the grip 88 just described see FIG. 9.

In FIG. 3, the stem 64 of the friction valve 22 is a round bar that is the connecting link between the grip 88 and the rotated-member 40. The three items become a rotating unit within the friction valve. The stem 64 has a pin 60 inserted in a drilled hole disposed in its outside diameter near its left end. The hole is normal to the longitudinal axis of the friction valve 22. The stem 64 also has the retaining ring 112 that is a standard shafting accessory inserted in an annular groove disposed in its outside diameter near its right end. This ring holds the stem 64 inside the valve 22 when fluid pressure in the left cap urges the rotating unit to the right. The stem 64 finally has an outer seal 104 inserted in an annular groove in its outside diameter near its right end to the right of the retaining ring 112. This seal is a standard o-ring seal that prevents fluid from leaking from the friction valve 22; otherwise, close tolerances and costly fits would be necessary to prevent this leakage.

For the radial arrangement of the features of the stem 64 just described see FIG. 6.

One alternative that immediately presents itself in regards to the making of the stem 64 is to make it and the rotated-member 40 out of one piece of machined stock and eliminate the connection between these two items to lower the unit cost on high volume production runs of the friction valve.

In FIG. 3, the rotated-member 40 of friction valve 22 is a single machined piece and has a left small portion 34 and a right large portion 42 that are end joined cylinders on the same central axis of the rotated-member 40. This central axis also has disposed upon it a coaxial recess that is made in the left face of the small portion 34 that extends into the larger portion 42. This recess is the coaxial portion of a bent passage 54. The remainder of the bent passage is made of an intersecting hole drilled from the center of the outside diameter of the large portion 42. The bent passage 54 is for directing and communicating fluid flow to different portions of the annular passage 56.

The rotated-member 40 is rotated around the longitudinal axis of the friction valve 22 and is moved in this rotation by the rotation of the stem 64. The stem 64 is moved in this rotation by the grip 88. The large portion of the rotated-member 40 has a coaxial recess on its central axis that is the left socket 46 that is a bore made in the right face of the large portion 42 that accommodates the left end of stem 64. The large portion 42 also has a pin slot 44 in its right face that is a radial slot that has a terminal that communicates with recess 46 and an opposite terminal that is blind. This slot engages pin 60 of the stem 64 and transfers torque from the stem to the rotated-member 40.

The small portion 34 of the rotated-member 40 forms a seat for the inner seal 35 that is a standard o-ring seal that prevents fluid from leaking around the rotated-member 40; otherwise, close tolerances and costly fits would be necessary to minimize this leakage.

For the radial arrangement of the features of the rotated-member 40 just described see FIG. 5.

To assemble the friction valve 22, use FIG. 3 as a reference, and do as follows: (1) Pick up stem 64 and put pin 90, retaining ring 112, and outer seal 104 on it and then insert the stem through the opening 108 of the end cap 72 until its right end is fully extended to make assembly ‘A’. (2) Pick up grip 88 and install spring 84 and ball 80 in their combination recess, install setscrew 100 in its recess, apply the symbol-tape to the outside diameter of the grip, and then put the socket 92 of the grip on the extended right stem end of assembly ‘A’, tighten the setscrew of the grip—Procedure (2) changes assembly ‘A’ to a larger assembly ‘B’. (3) Pick up casing 68 and put it on the flange 70 of assembly ‘B’ and roll this combination in a rolling machine to connect casing 68 to assembly ‘B’—Procedure (3) changes assembly ‘B’ to a larger assembly ‘C’. (4) Pick up rotated-member 40 and put seal 35 on it and put this combination into the recess 36 of cap 30 so that the socket 46 is facing outward—Procedure (4) makes assembly ‘D’. Pick up assembly ‘D’ and insert its flange 38 into the open end of the casing 68 of assembly ‘C’ and roll this combination in a rolling machine to complete the assembly of friction valve 22.

The friction valve 22 is operated by turning the grip 88 to one of the symbols 82 on the symbol-tape. The valve has been calibrated so that a grip symbol setting on the symbol-tape gives a predetermined restriction of fluid flow through the valve.

It was shown in the previous description that: (1) The grip of the damper 26 was separated from the damper so the damper itself could be used in an inaccessible location. (2) The manufacturing set-up costs of the device are low which keeps its selling price low during the initial low volume phase of marketing. (3) In application where two dampers have alternate active strokes one friction valve 22 can be used for their control with addition of more fluid ports. (4) An inexpensive low-pressure seal can be used for the outer seal 104 because the high pressure in the working oil from the active stroke of the damper is dropped across the annular passage 56 that precedes the outer seal in the flow path of the working oil. (5) The annular passage 56 is milled with a standard woodruff key seat cutter eliminating the need for expensive and sophisticated machining methods.

While we have shown and described an embodiment in accordance with the present invention, it should be clear to those skilled in the art that further embodiments may be made without departing from the scope of the present invention.

What is claimed is:

1. An adjustable and substantially accurately made fluid friction valve for use in a hydraulic circuit, said friction valve is comprised of the following:
a left cap, a casing, a right cap, a fluid reservoir, a stem, a stem retaining ring, a grip, each disposed on the same longitudinal axis;
a single annular passage for the variable restriction of fluid flow disposed within said left cap on an internal diameter of said cap, said annular passage is a groove having a varying cross-sectional area along its length with a smaller beginning terminal and a larger concluding terminal, said smaller beginning terminal is blind, and said larger concluding terminal communicates with a mid passage that communicates with said fluid reservoir;
a rotated-member with a bent passage for directing and communicating fluid flow to different portions of said annular passage, said rotated-member is rotated around said longitudinal axis and is moved in this rotation by the rotation of said stem, said stem is moved in this rotation by said grip;
a fastening means to connect said grip to said stem;
at least one left port that communicates with said bent passage of said rotated-member and connects said friction valve with said hydraulic circuit;
at least one right port that communicates with said fluid reservoir and connects said friction valve with said hydraulic circuit;
whereby the force required to produce a desired flow of fluid through said friction valve and said hydraulic circuit is adjusted.

2. The friction valve of claim 1 further including a grip stopping means that stops said grip incrementally in its rotation about said longitudinal axis with a ball, said ball partially moves into one recess of a ring of recesses disposed in the right end face of said right cap, said ring of recesses is centered around said longitudinal axis and said ball is urged by a spring into one of said recesses, said spring and ball are disposed in a recess in said grip that opposes said ring of recesses in said right cap.

3. The friction valve of claim 1 further including a grip position indicator said indicator is comprised of a distinctive mark and an opposing series of sequential symbols.

4. The friction valve of claim 3 wherein said distinctive mark is a recess in the right outermost rim of said right cap.

5. The friction valve of claim 3 wherein said sequential symbols are printed on a flexible adhesive tape that is applied to an outside diameter of said grip near its left end.

6. The friction valve of claim 1 further including an inner seal said seal is an o-ring disposed in a recess in said left cap that prevents pressurized fluid from bypassing said annular restriction passage and eliminates the need for close tolerances and costly fits.

7. The friction valve of claim 1 further including an outer seal to prevent fluid from leaking from said friction valve, said seal is an o-ring disposed in an annular recess in said stem and eliminates the need for close tolerances and costly fits.

8. The friction valve of claim 1 wherein the connection between said left cap and said casing is made by rolling said casing into an annular groove disposed in an outside diameter of said left cap.

8. The friction valve of claim 1 wherein the connection between said right cap and said casing is made by rolling said casing into an annular groove disposed in an outside diameter of said right cap.

9. The friction valve of claim 1 further including two wings for enhancing said grip said wings are disposed on the right end of said grip in opposing position to each other.

10. The friction valve of claim 1 wherein said fastening means is a setscrew disposed normal to said longitudinal axis in a threaded opening in said grip.
